(19) United States
(12) Patent Application Publication
(10) Pub. No.: US 2018/0039628 A1
(43) Pub. Date: Feb. 8, 2018

(54) SYSTEM AND METHOD FOR PROVIDING DYNAMIC RELOCATION OF TENANTS IN A MULTI-TENANT DATABASE ENVIRONMENT

(71) Applicant: ORACLE INTERNATIONAL CORPORATION, Redwood Shores, CA (US)

(72) Inventors: Jean de Lavarene, Versailles (FR); Saurabh Verma, Bangalore (IN); Vidya Hegde, Bangalore (IN); Krishna Chandra, Bangalore (IN); Aramvalarthanathan Namachivayam, Bangalore (IN)

(21) Appl. No.: 15/227,897

(22) Filed: Aug. 3, 2016

(51) Int. Cl. G06F 17/30; H04L 29/08

(52) U.S. Cl. CPC G06F 17/303; H04L 67/16

(57) ABSTRACT

Described herein are systems and methods for providing access to a database in a multi-tenant environment, including the use of a connection pool, and support for dynamic relocation of tenants. In accordance with an embodiment, a software application can obtain a connection from the connection pool, on behalf of a tenant, which enables the software application or tenant to access the database. A relocation process enables a tenant which is associated with a multi-tenant or other client application, to be relocated within the database environment, for example across a plurality of container databases, with near-zero downtime to the client application, including managing the draining of existing connections, and the migrating of new connections, without requiring changes to the underlying application.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF INVENTION

Embodiments of the invention are generally related to software application servers and databases, and are particularly related to systems and methods for providing access to a database in a multi-tenant environment, including the use of a connection pool, and support for dynamic relocation of tenants.

### BACKGROUND

Generally described, in a database environment, a connection pool operates as a cache of connection objects, each of which represents a connection that can be used by a software application to connect to a database. At runtime, an application can request a connection from the connection pool. If the connection pool includes a connection that can satisfy the particular request, it can return that connection to the application for its use. In some instances, if no suitable connection is found, then a new connection can be created and returned to the application. The application can borrow the connection to access the database and perform some work, and then return the connection to the pool, where it can then be made available for subsequent connection requests from the same, or from other, applications.

### SUMMARY

Described herein are systems and methods for providing access to a database in a multi-tenant environment, including the use of a connection pool, and support for dynamic relocation of tenants. In accordance with an embodiment, a software application can obtain a connection from the connection pool, on behalf of a tenant, which enables the software application or tenant to access the database. A relocation process enables a tenant which is associated with a multi-tenant or other client application, to be relocated within the database environment, for example across a plurality of container databases, with near-zero downtime to the client application, including managing the draining of existing connections, and the migrating of new connections, without requiring changes to the underlying application.

### BRIEF DESCRIPTION OF THE FIGURES

FIG. 1 illustrates a system that includes a connection pool, in accordance with an embodiment.

FIG. 2 further illustrates a system that includes a connection pool, including support for use of a sharded database, in accordance with an embodiment.

FIG. 3 further illustrates a system that includes a connection pool, including support for use in a multi-tenant environment, in accordance with an embodiment.

FIG. 4 illustrates support for dynamic relocation of a tenant, in a connection pool environment, in accordance with an embodiment.

FIG. 5 further illustrates support for dynamic relocation of a tenant, in a connection pool environment, in accordance with an embodiment.

FIG. 6 further illustrates support for dynamic relocation of a tenant, in a connection pool environment, in accordance with an embodiment.

FIG. 7 further illustrates support for dynamic relocation of a tenant, in a connection pool environment, in accordance with an embodiment.

FIG. 8 further illustrates support for dynamic relocation of a tenant, in a connection pool environment, in accordance with an embodiment.

FIG. 9 further illustrates support for dynamic relocation of a tenant, in a connection pool environment, in accordance with an embodiment.

FIG. 10 illustrates a method of providing support for dynamic relocation of a tenant, in a connection pool environment, in accordance with an embodiment.

### DETAILED DESCRIPTION

As described above, a connection pool operates as a cache of connection objects, each of which represents a connection that can be used by a software application to connect to a database. At runtime, an application can request a connection from the connection pool. If the connection pool includes a connection that can satisfy the particular request, it can return that connection to the application for its use. In some instances, if no suitable connection is found, then a new connection can be created and returned to the application. The application can borrow the connection to access the database and perform some work, and then return the connection to the pool, where it can then be made available for subsequent connection requests from the same, or from other, applications.

Creating connection objects can be costly in terms of time and resources. For example, tasks such as network communication, authentication, transaction enlistment, and memory allocation, all contribute to the amount of time and resources it takes to create a particular connection object. Since connection pools allow the reuse of such connection objects, they help reduce the number of times that the various objects must be created.

One example of a connection pool is Oracle Universal Connection Pool (UCP), which provides a connection pool for caching Java Database Connectivity (JDBC) connections. For example, the connection pool can operate with a JDBC driver to create connections to a database, which are then maintained by the pool; and can be configured with properties that are used to further optimize pool behavior, based on the performance and availability requirements of a requesting software application.

### Connection Labeling

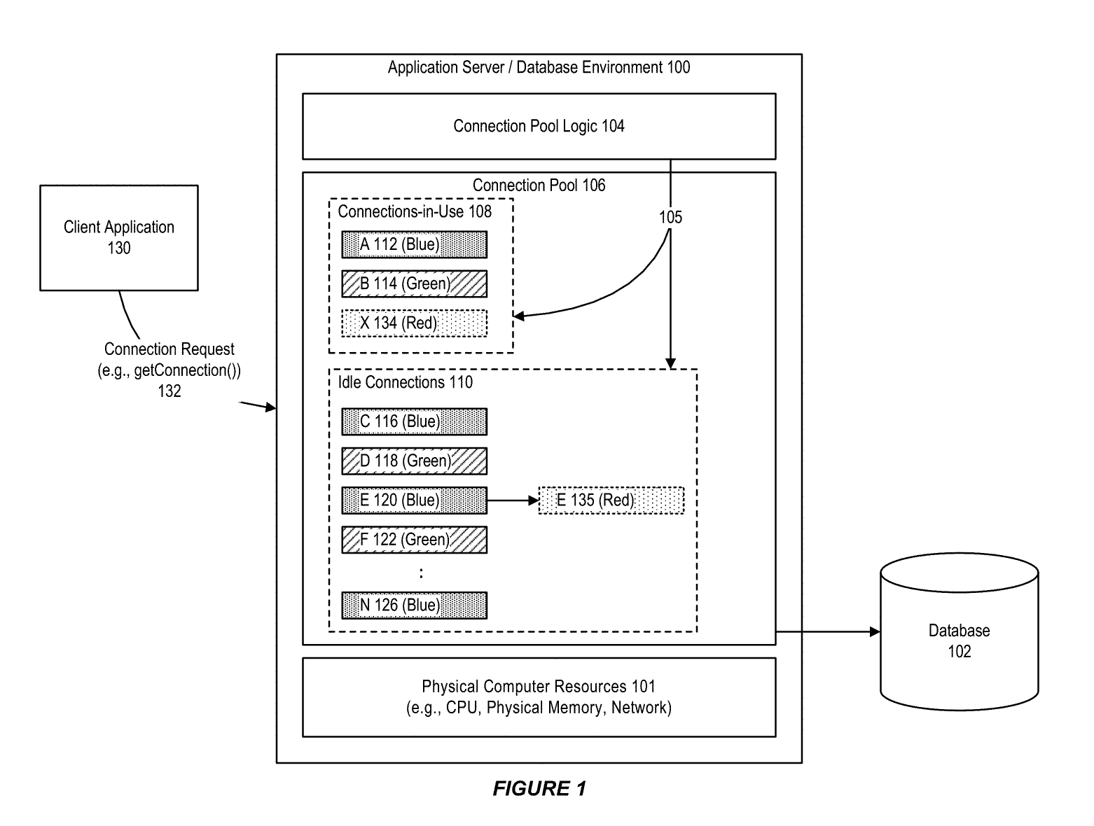

FIG. 1 illustrates a system that includes a connection pool, in accordance with an embodiment.

As illustrated in FIG. 1, in accordance with an embodiment, an application server or database environment 100, which includes physical computer resources 101 (e.g., a processor/CPU, memory, and network components), for example an Oracle WebLogic Server, Oracle Fusion Middleware, or other application server or database environment, can include or provide access to a database 102, for example an Oracle database, or other type of database.

As further illustrated in FIG. 1, in accordance with an embodiment, the system also includes a connection pool logic 104 or program code, which when executed by a computer controls 105 the creation and use of connection objects in a connection pool 106, including, for example, connections that are currently in use 108 by a software application, and connections that are idle 110, or are not currently being used.

Software applications can initialize connections retrieved from a connection pool, before using the connection to access, or perform work at the database. Examples of initialization can include simple state re-initializations that require method calls within the application code, or more complex initializations including database operations that require round trips over a network. The computational cost of these latter types of initialization may be significant.

Some connection pools (for example, UCP) allow their connection pools to be configured using connection pool properties, that have get and set methods, and that are available through a pool-enabled data source instance. These get and set methods provide a convenient way to programmatically configure a pool. If no pool properties are set, then a connection pool uses default property values.

In accordance with an embodiment, labeling connections allows a client software application to attach arbitrary name/value pairs to a connection. The application can then request a connection with a desired label from the connection pool. By associating particular labels with particular connection states, an application can potentially retrieve an already-initialized connection from the pool, and avoid the time and cost of re-initialization. Connection labeling does not impose any meaning on user-defined keys or values; the meaning of any user-defined keys and values is defined solely by the application.

For example, as illustrated in FIG. 1, in accordance with an embodiment, the connection pool can include a plurality of connections that are currently in use by software applications, here indicated as connections A 112 and B 114. Each of the connections can be labeled, for example connection A is labeled (Blue) and connection B is labeled (Green). These labels/colors are provided for purposes of illustration, and as described above can be arbitrary name/value pairs attached to a connection by a client application. In accordance with various embodiments, different types of labels can be used, to distinguish between different connection types; and different applications can attach different labels/colors to a particular connection type.

As further illustrated in FIG. 1, in accordance with an embodiment, the connection pool can also include a plurality of connections that are idle, or are not currently being used by software applications, here indicated as connections C 116, D 118, E 120, F 122, G 124 and N 126. Each of the idle connections can be similarly labeled, in this illustration as (Blue) or (Green), and again these labels/colors are provided for purposes of illustration.

As further illustrated in FIG. 1, in accordance with an embodiment, if a software application 130 wishes to make a request on the database, using a particular type of connection, for example a (Red) connection, then the application can make a “getConnection(Red)” request 132. In response, the connection pool logic will either create a new (Red) connection, here indicated as X 134 (Red); or repurpose an existing idle connection from (Blue or Green) to (Red), here indicated as E 135 (Red).

### Sharded Databases

In accordance with an embodiment, sharding is a database-scaling technique which uses a horizontal partitioning of data across multiple independent physical databases. The part of the data which is stored in each physical database is referred to as a shard. From the perspective of a software client application, the collection of all of the physical databases appears as a single logical database.

In accordance with an embodiment, the system can include support for use of a connection pool with sharded databases. A shard director or listener provides access by software client applications to database shards. A connection pool (e.g., UCP) and database driver (e.g., a JDBC driver) can be configured to allow a client application to provide a shard key, either during connection checkout or at a later time; recognize shard keys specified by the client application; and enable connection by the client application to a particular shard or chunk. The approach enables efficient re-use of connection resources, and faster access to appropriate shards.

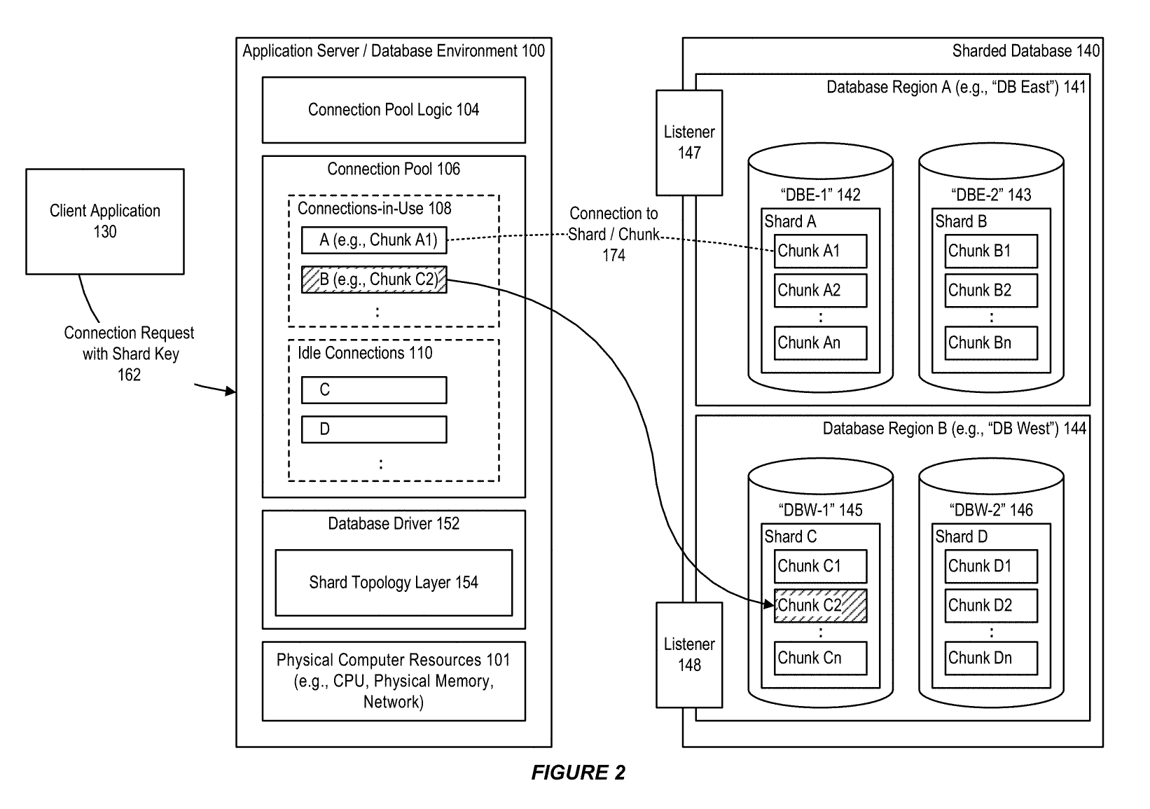

FIG. 2 further illustrates a system that includes a connection pool, including support for use of a sharded database, in accordance with an embodiment.

In accordance with an embodiment, a database table can be partitioned using a shard key (SHARD_KEY), for example as one or more columns that determine, within a particular shard, where each row is stored. A shard key can be provided in a connect string or description as an attribute of connect data (CONNECT_DATA). Examples of shard keys can include a VARCHAR2, CHAR, DATE, NUMBER, or TIMESTAMP in the database. In accordance with an embodiment, a sharded database can also accept connections without a shard key or shard group key.

In accordance with an embodiment, to reduce the impact of resharding on system performance and data availability, each shard can be subdivided into smaller pieces or chunks. Each chunk acts as a unit of resharding that can be moved from one shard to another. Chunks also simplify routing, by adding a level of indirection to the shard key mapping.

For example, each chunk can be automatically associated with a range of shard key values. A user-provided shard key can be mapped to a particular chunk, and that chunk mapped to a particular shard. If a database operation attempts to operate on a chunk that is not existent on a particular shard, then an error will be raised. When shard groups are used, each shard group is a collection of those chunks that have a specific value of shard group identifier.

A shard-aware client application can work with sharded database configurations, including the ability to connect to one or multiple database shards in which the data is partitioned based on one or more sharding methods. Each time a database operation is required, the client application can determine the shard to which it needs to connect.

In accordance with an embodiment, a sharding method can be used to map shard key values to individual shards. Different sharding methods can be supported, for example: hash-based sharding, in which a range of hash values is assigned to each chunk, so that upon establishing a database connection the system applies a hash function to a given value of the sharding key, and calculates a corresponding hash value which is then mapped to a chunk based on the range to which that value belongs; range-based sharding, in which a range of shard key values is assigned directly to individual shards; and list-based sharding, in which each shard is associated with a list of shard key values.

As illustrated in FIG. 2, in accordance with an embodiment a sharded database 140 can comprise a first database region A (here indicated as “DB East”, DBE) 141, including sharded database instances “DBE-1” 142, with a shard A stored as chunks A1, A2, . . . An; and “DBE-2” 143, with a shard B stored as chunks B1, B2, Bn.

As further illustrated in FIG. 2, in accordance with an embodiment, a second database region B (here indicated as “DB West”, DBW) 144, includes sharded database instances “DBW-1” 145, with a shard C stored as chunks C1, C2, Cn; and “DBW-2” 146, with a shard D stored as chunks D1, D2, . . . Dn.

In accordance with an embodiment, each database region or group of sharded database instances can be associated with a shard director or listener (e.g., an Oracle Global Service Managers (GSM) listener, or another type of listener). For example, as illustrated in FIG. 2, a shard director or listener 147 can be associated with the first database region A; and another shard director or listener 148 can be associated with the second database region B. The system can include a database driver (e.g., a JDBC driver) 152 that maintains a shard topology layer 154, which over a period of time learns and caches shard key ranges to the location of each shard in a sharded database.

In accordance with an embodiment, a client application can provide one or more shard keys to the connection pool during a connection request 162; and, based on the one or more shard keys, and information provided by the shard topology layer, the connection pool can route the connection request to a correct or appropriate shard.

In accordance with an embodiment, the connection pool can also identify a connection to a particular shard or chunk by its shard keys, and allow re-use of a connection when a request for a same shard key is received from a particular client application.

For example, as illustrated in FIG. 2, in accordance with an embodiment, a connection to a particular chunk (e.g., chunk A1) can be used to connect 174, to that chunk. If there are no available connections in the pool to the particular shard or chunk, the system can attempt to repurpose an existing available connection to another shard or chunk, and re-use that connection. The data distribution across the shards and chunks in the database can be made transparent to the client application, which also minimizes the impact of re-sharding of chunks on the client.

When a shard-aware client application provides one or more shard keys to the connection pool, in association with a connection request; then, if the connection pool or database driver already has a mapping for the shard keys, the connection request can be directly forwarded to the appropriate shard and chunk, in this example, to chunk C2.

When a shard-aware client application does not provide a shard key in association with the connection request; or if the connection pool or database driver does not have a mapping for a provided shard key; then the connection request can be forwarded to an appropriate shard director or listener.

### Multi-Tenant Environments

In accordance with an embodiment, the system can include support for cloud-based or multi-tenant environments using connection labeling. For example, a multi-tenant cloud environment can include an application server or database environment that includes or provides access to a database for use by multiple tenants or tenant applications, in a cloud-based environment.

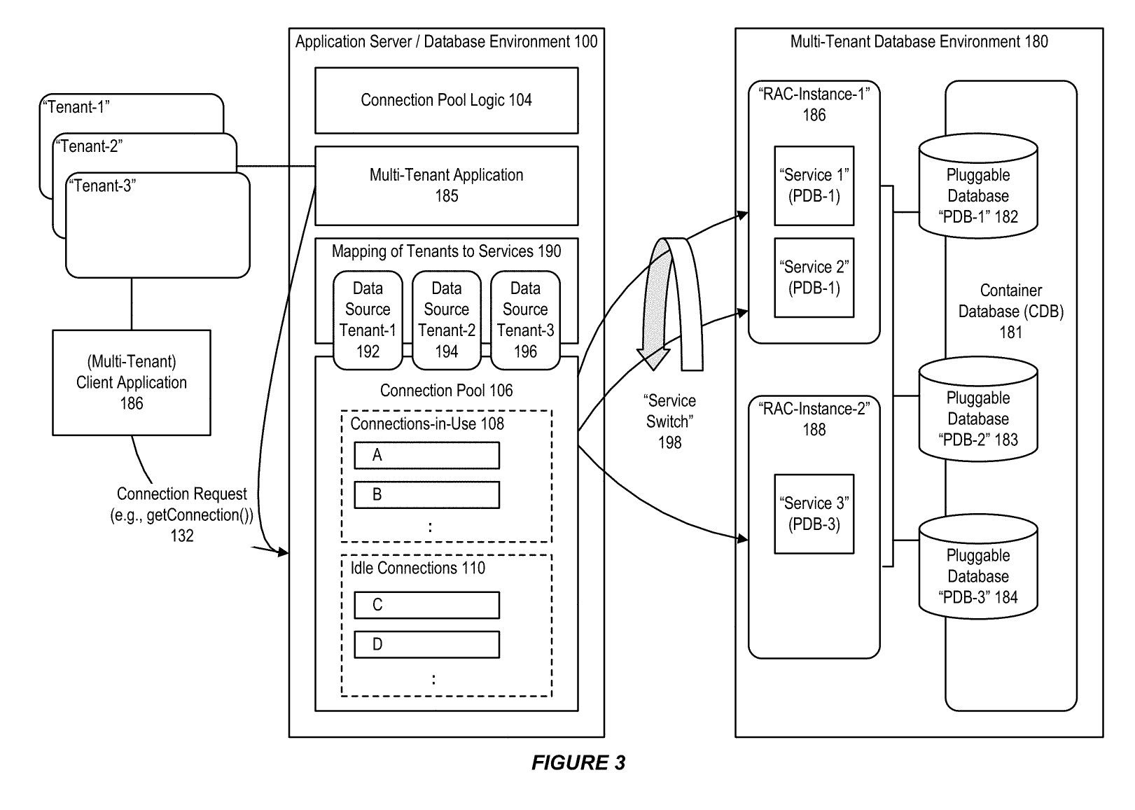

FIG. 3 further illustrates a system that includes a connection pool, including support for use in a multi-tenant environment, in accordance with an embodiment.

Software applications, which can be accessed by tenants via a cloud or other network, may, similarly to the environments described above, initialize connections retrieved from a connection pool before using the connection.

As described above, examples of initialization can include simple state re-initializations that require method calls within the application code, or more complex initializations including database operations that require round trips over a network.

As also described above, labeling connections allows an application to attach arbitrary name/value pairs to a connection, so that the application can then request a connection with a desired label from the connection pool, including the ability to retrieve an already-initialized connection from the pool and avoid the time and cost of re-initialization.

As illustrated in FIG. 3, in accordance with an embodiment, a multi-tenant database environment 180 can include, for example, a container database (CDB) 181, and one or more pluggable database (PDB), here illustrated as “PDB-1” 182, “PDB-2” 183, and “PDB-3” 184.

In accordance with an embodiment, each PDB can be associated with a tenant, here illustrated as “Tenant-1”, “Tenant-2”, and “Tenant-3”, of a multi-tenant application that is either hosted by the application server or database environment 185, or provided as an external client application 186, and which provides access to the database environment through the use of one or more Oracle Real Application Cluster (RAC) instances 186, 188, including in this example “RAC-Instance-1”, and “RAC-Instance-2”; one or more services, including in this example Service-1″, “Service-2”, and “Service-3”, and a mapping of tenants to services 190.

In the example illustrated in FIG. 3, an application being used by a tenant to access the database environment, can make connection requests associated with that tenant's data source 192, 194, 196, and the system can switch services 198 if necessary, to utilize connections to existing RAC instances or PDBs.

### Server-Side Connection Pools

In accordance with an embodiment, the system can utilize a server-side connection pool tagging feature, such as that provided, for example, by Oracle Database Resident Connection Pool (DRCP). A server-side connection pool tagging feature allows user applications or clients to selectively obtain a connection to a database environment, based on use of a single tag that is understood by that database environment.

In accordance with an embodiment, only one tag is associated per connection. The database server does not communicate the tag value to the user applications or clients, but rather communicates a tag-match (for example, as a Boolean value).

### Dynamic Relocation of a Tenant in the Pool

In accordance with an embodiment, the system can include support for dynamic relocation of tenants. A software application can obtain a connection from the connection pool, on behalf of a tenant, which enables the software application or tenant to access the database. A relocation process enables a tenant which is associated with a multi-tenant or other client application, to be relocated within the database environment, for example across a plurality of container databases, with near-zero downtime to the client application, including managing the draining of existing connections, and the migrating of new connections, without requiring changes to the underlying application.

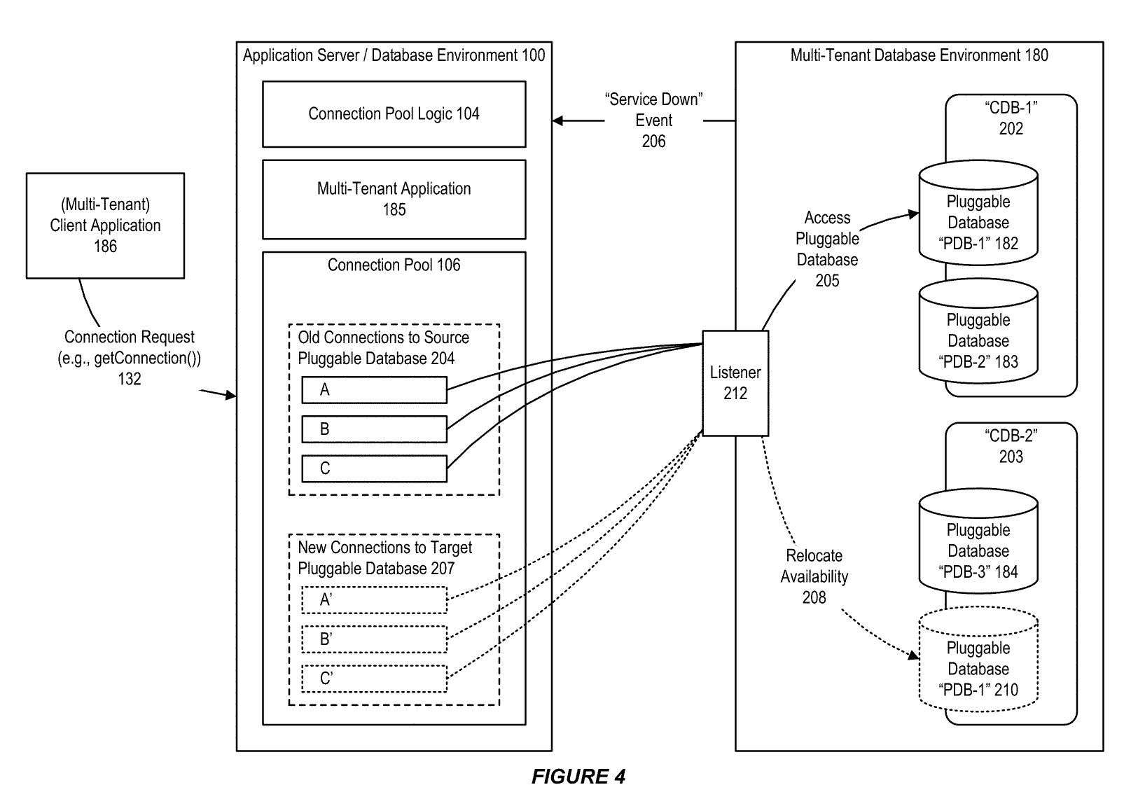

FIGS. 4-9 illustrate support for dynamic relocation of a tenant, in a connection pool environment, in accordance with an embodiment.

As illustrated in FIG. 4, in accordance with an embodiment, a database, for example a container database (e.g., “CDB-1” 202), or another type of database, supports the use of a plurality of connections 204.

A tenant, which is associated with a multi-tenant or other client application hosted either by the application server or database environment, or provided as an external client application, can use the connection pool to access the database, including where appropriate accessing a pluggable database of a container database, via a database service.

For example, in accordance with an embodiment, each particular tenant can be associated with its own particular pluggable database at the container database, and can use connections provided by the connection pool, to access (e.g., 205) the particular pluggable database associated with that tenant, via a database service associated with the particular pluggable database.

In accordance with an embodiment, if the database environment changes, for example a second container database (e.g., “CDB-2” 203) is added to the system, or in response to an application server that is hosting the connection pool receiving a service-down event 206 from the database environment, the system can provide new connections 207 to a new database location, for use by a particular tenant.

For example, in accordance with an embodiment, the system can initiate a migration of a pluggable database, for use by a tenant, including draining connections that are associated with an original pluggable database location and its associated database service (for example, those connections associated with “PDB-1” 182, in “CDB-1” 202); and migrating or otherwise relocating the availability of those connections 208 to a new pluggable database location and associated database service (for example, here illustrated as “PDB-1” 210, in “CDB-2” 203).

This enables the connection pool to support near-zero-downtime tenant relocation, by draining the existing connections associated with a tenant's original location, and creating new connections that point to the tenant's new location, in a manner that is transparent to the client or tenant application.

For example, in a multi-tenant environment, the system supports moving a pluggable database associated with a particular tenant, from a first Oracle Real Application Cluster (RAC) database, to a second RAC database; or from a first container database, to a second container database.

However, these pluggable databases generally operate as different/separate databases, which can result in connections being lost.

To address this, in accordance with an embodiment, in the case of an application that is currently using a connection string which points to a listener 212 of an original container database (e.g., “CDB-1”), the listener can be configured to redirect connection requests to a new location or container database (e.g., “CDB-2”). This allows the listener to send a redirect to the database driver at the application server, which in turn causes the database driver to send the new connection requests to the new container database.

Additionally, existing connection requests must be drawn away from the original container database. However, the pool may not yet know about the existence of the new container database, since it is considered a different database.

To address this, in accordance with an embodiment, a system event notification (e.g., an Oracle Notification Service event) can be used to inform the connection pool that the pluggable database is shutting down, and to close its associated connections and prepare for migration to a new database service associated with a new location.

Generally, there is a small period of time during which the new database location will not be immediately available to support new connections. During this time, existing connections will be closed, and the connection pool will not create a new connection until it receives a new request. This can result in a slight system downtime, for example, due to the need to update redo logs, including stopping the redo logs to switch over the source of truth to the new location.

For example, in the example illustrated in FIG. 4, in which it is desired to migrate a pluggable database (e.g., “PDB-1”), from a first container database (e.g., “CDB-1”), to a second container database (e.g., “CDB-2”); then, in accordance with an embodiment, the process involved in relocation of the pluggable database includes:

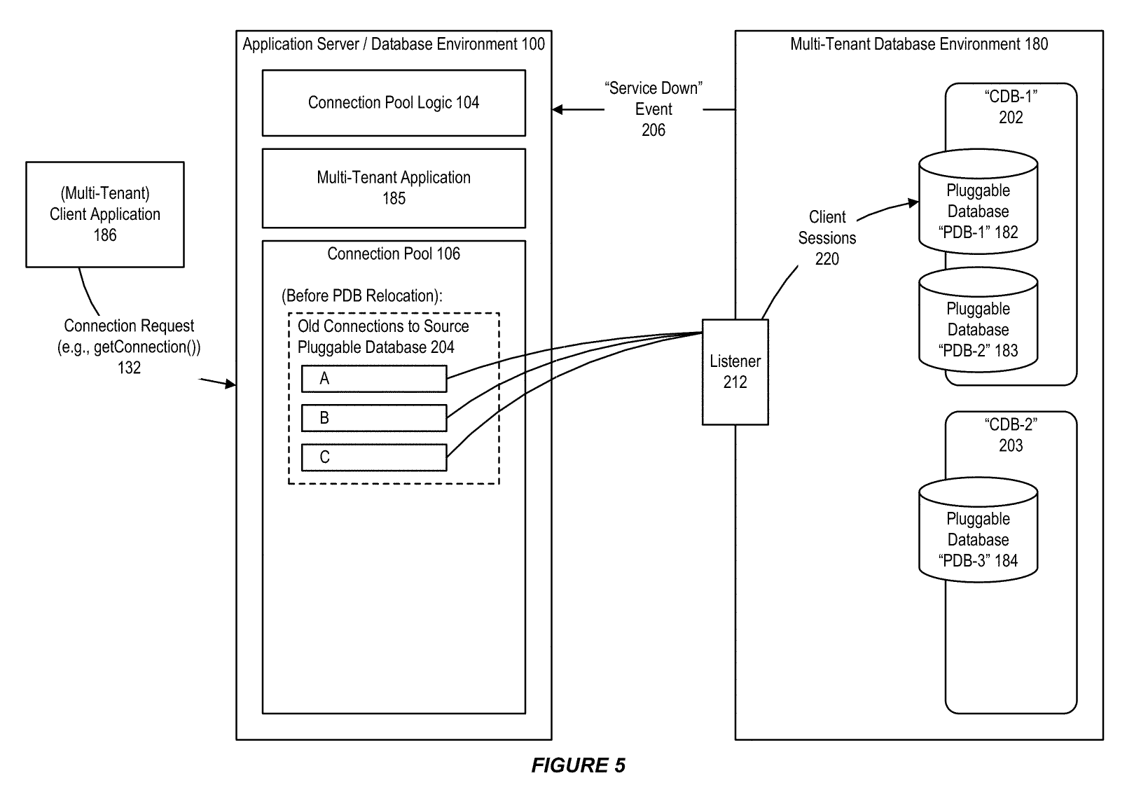

1. Initiating relocation of the pluggable database. For example, as illustrated in FIG. 5, the server can initiate relocation of a pluggable database by running an “alter pluggable database relocate” command, which will affect those sessions 220 running on the original pluggable database.

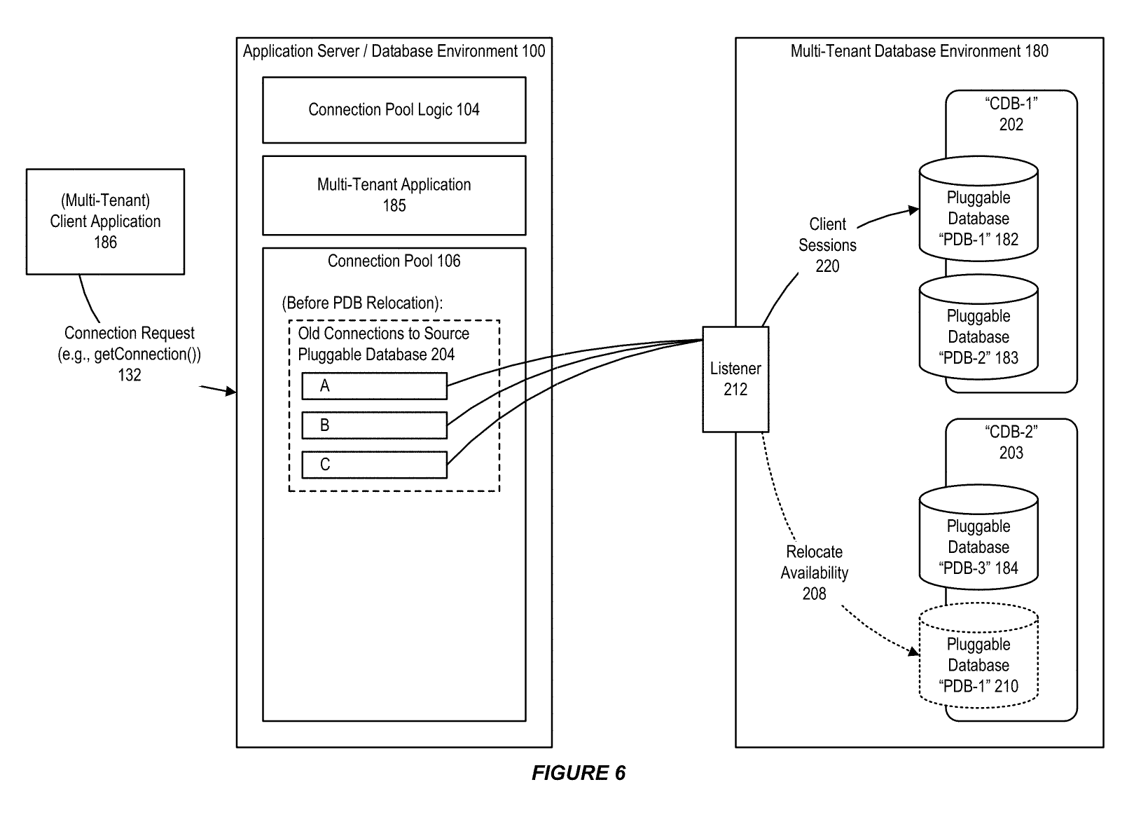

2. Open the pluggable database at the new location, and then terminate all of the client sessions on the original instance container database. For example, as illustrated in FIG. 6, the system can respond to the “alter pluggable database relocate” command by opening the pluggable database “PDB-1” in container database instance “CDB-2”, and then terminating all of the client sessions on the original container database instance “CDB-1”. After that, it will close the pluggable database “PDB-1” on “CDB-1”, and flush its buffer cache.

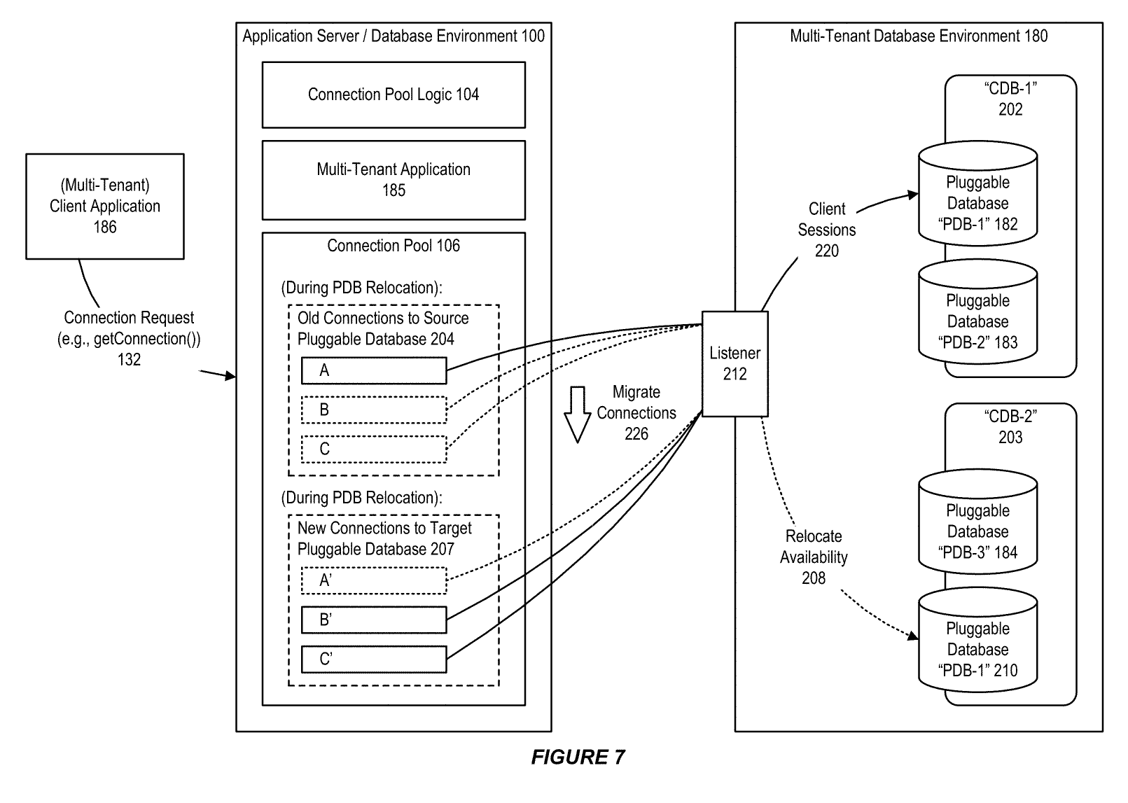

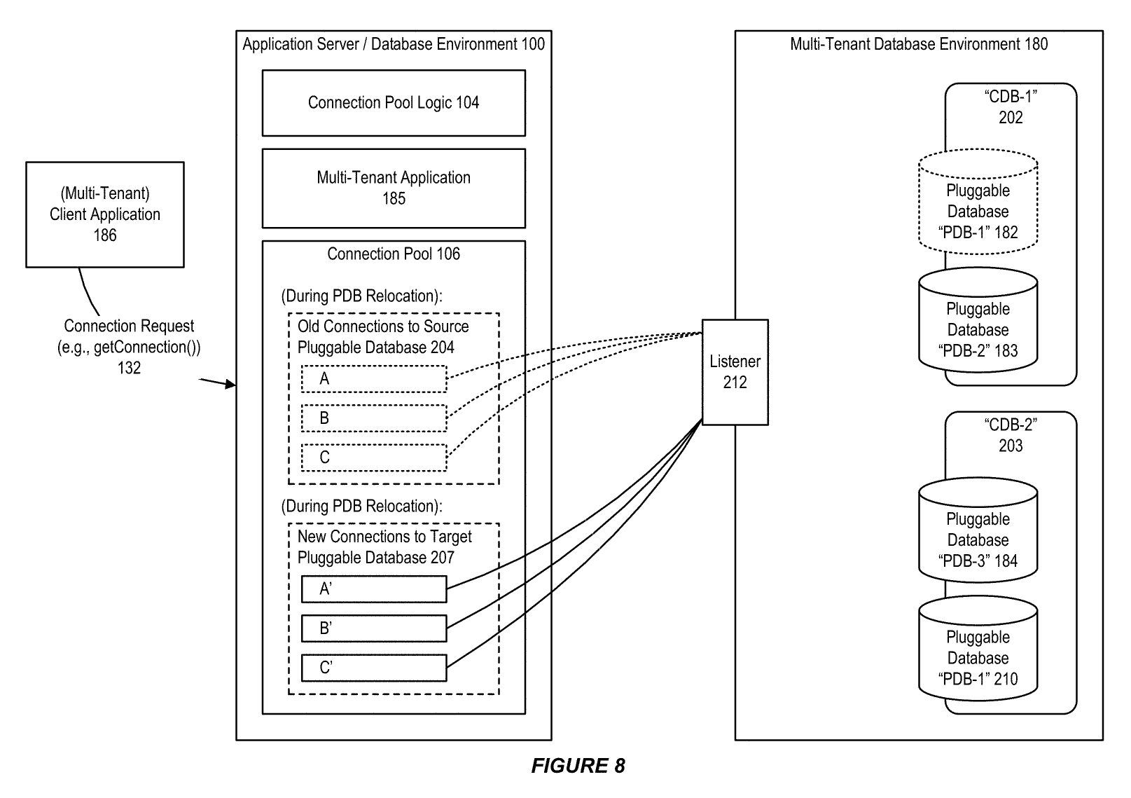

3. Enable clients to reconnect to the new database location. For example, as illustrated in FIG. 7, clients will then need to reconnect to the (now migrated) service 226 themselves. The connection pool enables this in a transparent manner to the application, including, for example, as illustrated in FIG. 8, by draining existing connections upon receiving a service down event from the server, and re-creating new connections to the migrated pluggable database.

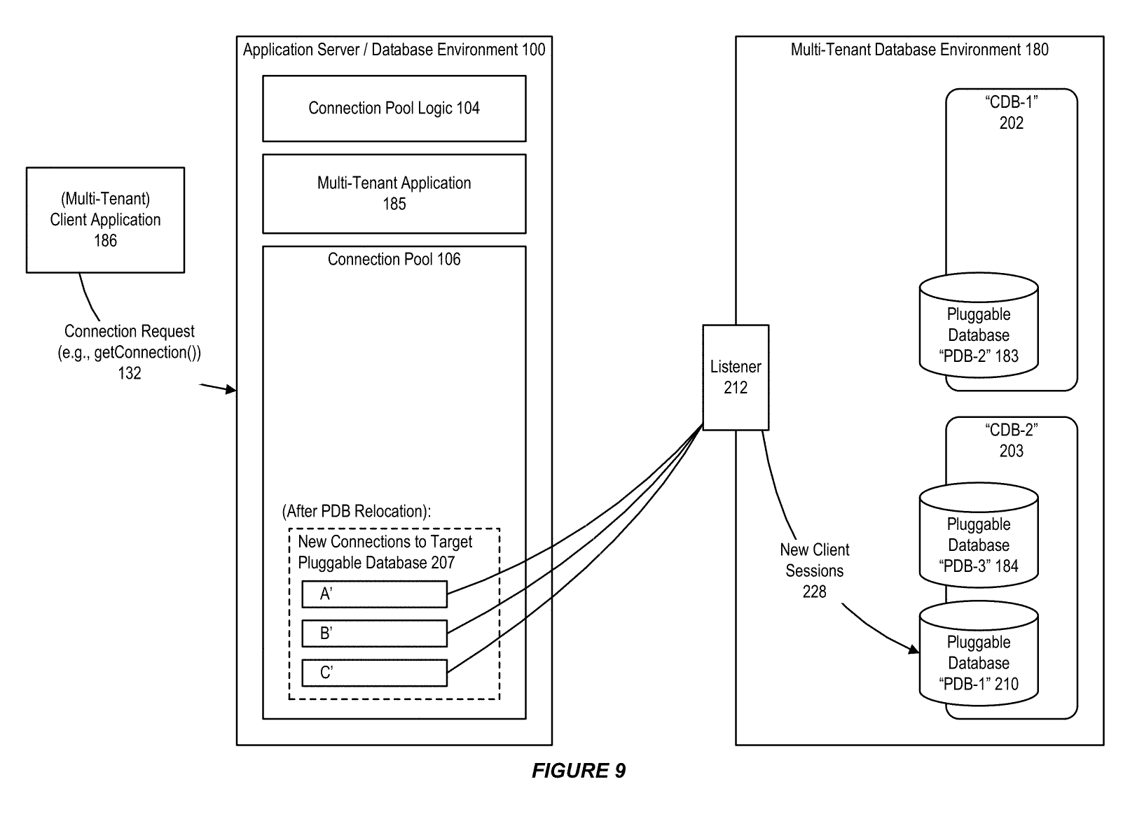

4. Forward connection requests to the new location. For example, as illustrated in FIG. 9, on the server side, the listener will forward the new connection requests 228 from the connection pool to the new target container database (e.g., “CDB-2”) once the migration is complete. Applications do not need to change their connect string, which makes the relocation process transparent to the application.

Dynamic Relocation Process

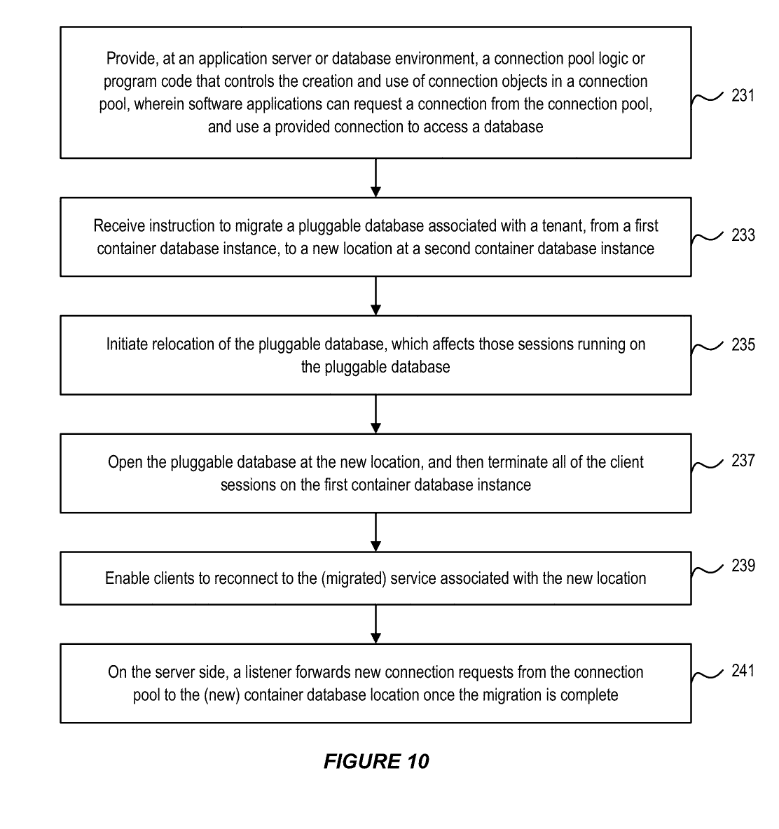

FIG. 10 illustrates a method of providing support for the dynamic relocation of a tenant, in a connection pool environment, in accordance with an embodiment.

As illustrated in FIG. 10, in accordance with an embodiment, at step 231, at an application server or database environment, a connection pool logic or program code is provided that controls the creation and use of connection objects in a connection pool, wherein software applications can request a connection from the connection pool, and use a provided connection to access a database.

As illustrated in FIG. 10, in accordance with an embodiment, at step 233, an instruction is received to migrate a pluggable database associated with a tenant, from a first container database instance, to a new location at a second container database instance.

At step 235, the server initiates relocation of the pluggable database, which affects those sessions running on the pluggable database.

At step 237, the system responds by opening the pluggable database at the new location, and then terminating all of the client sessions on the first container database instance.

At step 239, clients are enabled to reconnect to the (migrated) service associated with the new location.

At step 241, on the server side, a listener forwards new connection requests from the connection pool to the (new) container database location once the migration is complete.

Embodiments of the present invention may be conveniently implemented using one or more conventional general purpose or specialized digital computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

In some embodiments, the present invention includes a computer program product which is a non-transitory storage medium or computer readable medium (media) having instructions stored thereon/in which can be used to program a computer to perform any of the processes of the present invention. Examples of the storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

The foregoing description of embodiments of the present invention has been provided for the purposes of illustration and description. It is not intended to be exhaustive or to limit the invention to the precise forms disclosed. Many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated.

What is claimed is:

1. A system for providing access to a database in a multi-tenant environment, including the use of a connection pool, and support for dynamic relocation of tenants, comprising:
a computer including a processor, and at least one of an application server or database environment executing thereon;
wherein the computer controls creation and use of connection objects in a connection pool that enables software applications to request a connection from the connection pool, and use a provided connection to access a database; and
wherein the connection pool enables a tenant associated with a client application, to be relocated across a plurality of database locations, including
controlling draining of existing connections to a database location originally associated with the tenant, and
migrating of new connections to a new database location associated with the tenant.

2. The system of claim 1, wherein during the draining of existing connections, and migrating of new connections from a first pluggable database at a first container database, to a new location at a second container database,
a second pluggable database is opened at the second container database, and
client sessions are terminated on the first pluggable database, and are enabled to reconnect to a migrated service associated with the new location.

3. The system of claim 1, wherein a system event is used to inform the connection pool that the database location originally associated with the tenant is shutting down, and to close its associated connections and prepare for migration to a new database service associated with the new database location.

4. The system of claim 1, further comprising a listener configured to redirect connection requests to at least one of a new location or container database, and to send a redirect to a database driver at the application server or database environment, which in turn causes the database driver to send new connection requests to the new location or container database.

5. The system of claim 1, wherein the system enables software applications to associate particular labels with particular connection states.

6. The system of claim 1, wherein the connection pool supports a plurality of tenants, including a different database location associated with each tenant.

7. A method for providing access to a database in a multi-tenant environment, including the use of a connection pool, and support for dynamic relocation of tenants, comprising:
providing, at a computer including a processor, at least one of an application server or database environment executing thereon, a connection pool that includes connection objects and that enables software applications to request a connection from the connection pool, and use a provided connection to access a database; and
relocating, by the connection pool, a tenant associated with a client application, across a plurality of database locations, including
controlling draining of existing connections to a database location originally associated with the tenant, and
migrating of new connections to a new database location associated with the tenant.

8. The method of claim 7, wherein during the draining of existing connections, and migrating of new connections from a first pluggable database at a first container database, to a new location at a second container database,
a second pluggable database is opened at the second container database, and
client sessions are terminated on the first pluggable database, and are enabled to reconnect to a migrated service associated with the new location.

9. The method of claim 7, wherein a system event is used to inform the connection pool that the database location originally associated with the tenant is shutting down, and to close its associated connections and prepare for migration to a new database service associated with the new database location.

10. The method of claim 7, further comprising providing a listener configured to redirect connection requests to at least one of a new location or container database, and to send a redirect to a database driver at the application server or database environment, which in turn causes the database driver to send new connection requests to the new location or container database.

11. The method of claim 7, wherein software applications are enabled to associate particular labels with particular connection states.

12. The method of claim 7, wherein the connection pool supports a plurality of tenants, including a different database location associated with each tenant.

13. A non-transitory computer readable storage medium, including instructions stored thereon which when read and executed by one or more computers cause the one or more computers to perform the method comprising:
providing, at a computer including a processor, at least one of an application server or database environment executing thereon, a connection pool that includes connection objects and that enables software applications to request a connection from the connection pool, and use a provided connection to access a database; and
relocating, by the connection pool, a tenant associated with a client application, across a plurality of database locations, including
controlling draining of existing connections to a database location originally associated with the tenant, and
migrating of new connections to a new database location associated with the tenant.

14. The non-transitory computer readable storage medium of claim 13, wherein during the draining of existing connections, and migrating of new connections from a first pluggable database at a first container database, to a new location at a second container database,
a second pluggable database is opened at the second container database, and
client sessions are terminated on the first pluggable database, and are enabled to reconnect to a migrated service associated with the new location.

15. The non-transitory computer readable storage medium of claim 13, wherein a system event is used to inform the connection pool that the database location originally associated with the tenant is shutting down, and to close its associated connections and prepare for migration to a new database service associated with the new database location.

16. The non-transitory computer readable storage medium of claim 13, further comprising providing a listener configured to redirect connection requests to at least one of a new location or container database, and to send a redirect to a database driver at the application server or database environment, which in turn causes the database driver to send new connection requests to the new location or container database.

17. The non-transitory computer readable storage medium of claim 13, wherein software applications are enabled to associate particular labels with particular connection states.

18. The non-transitory computer readable storage medium of claim 13, wherein the connection pool supports a plurality of tenants, including a different database location associated with each tenant.
